(19) United States
(12) Patent Application Publication
(10) Pub. No.: US 2009/0249322 A1
(43) Pub. Date: Oct. 1, 2009

(54) TECHNIQUES FOR UPDATING SOFTWARE

(75) Inventors: Nobukazu Sugiyama, San Diego, CA (US); Dipendu Saha, San Diego, CA (US); George Williams, San Diego, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION OF JAPAN, Tokyo (JP); SONY ELECTRONICS, INC., Park Ridge, NJ (US)

(21) Appl. No.: 12/057,179

(22) Filed: Mar. 27, 2008

(51) Int. Cl. G06F 9/44

(52) U.S. Cl. 717/173

(57) ABSTRACT

Techniques for updating software include downloading a software image update from a first data structure wherein the software update image includes one or more content identifiers. Content is then downloaded from a second data structure based on the one or more content identifiers. The content may then be output during or after the software update download and installation process.

### BACKGROUND OF THE INVENTION

FIG. 1 illustrates a technique for updating software according to the conventional art. A typical system includes a device 110 that includes a network interface 115, a processing unit 120, an audio/video (A/V) output 125 and memory 130. The device 110 is coupled to a display 135 through the A/V output 125. The A/V output 125 converts image data to pixel data for output on the display 135. The processing unit 120 implements one or more functions of the device 110 by executing software 140 stored in the memory 130.

The software 140 may be updated by downloading and installing a software update image 145. The software update image 145 may be downloaded from an update server 140. The software update image 145 may include content 155 for output on the display 135 during download and installation of the software update 145. The content 155 may be images (e.g., pictures), audio (e.g., music), video, graphics, and/or the like. For example, the content 155 may be software version information, such as an introduction to new features contained in the software update. In another example, the content 155 may be a product offering (e.g., advertisement). In yet another example, the content 155 may be entertainment information.

Typically, the content 155 included in the software update image 145 may change while the software update itself may not change. As a result, the entire software update image 145 needs to be changed if any portion of the content 155 is changed. In other instances, only a given portion of the content may be displayed, but the software update image 145 includes all the content 155. For example, the content 155 may include English, Spanish, French, German, Japanese and Chinese versions. However, only the content in a given version may be output on the display 135 based upon a configuration parameter (e.g., user setting or preference) for the device 110. As a result, the software update image 145 will be a bigger image than if the image did not include the content 155. Accordingly, there is a continued need for improved techniques for delivering and display content along with downloading and updating software.

### SUMMARY OF THE INVENTION

Embodiments of the present technology are directed toward techniques for outputting content, such as pictures, video and/or audio, associated with a software update. In one embodiment, a system includes an update server, a content server and a network device. The update server stores one or more software update images, wherein at least one of the software update images includes one or more content identifiers. The content server stores one or more content items associated with one or more of the software update images. The network device may download a given software update image that includes one or more content identifiers from the update server. The network device may then download at least one of the content items from the content server based on the one or more content identifiers included in the given software update image and outputting the item on one or more input/output interfaces of the device.

In another embodiment, a method includes downloading a software update image. One or more uniform resource identifiers and a timetable are received with the software update image. Content at the one or more uniform resource identifiers is then downloaded. Thereafter, the method determines if a next progress point has been reached according to the timetable. If the next progress point has been reached, a next portion of the content is output.

### BRIEF DESCRIPTION OF THE DRAWINGS

Embodiments of the present invention are illustrated by way of example and not by way of limitation, in the figures of the accompanying drawings and in which like reference numerals refer to similar elements and in which:

FIG. 1 shows a block diagram of a technique for updating software according to the conventional art.

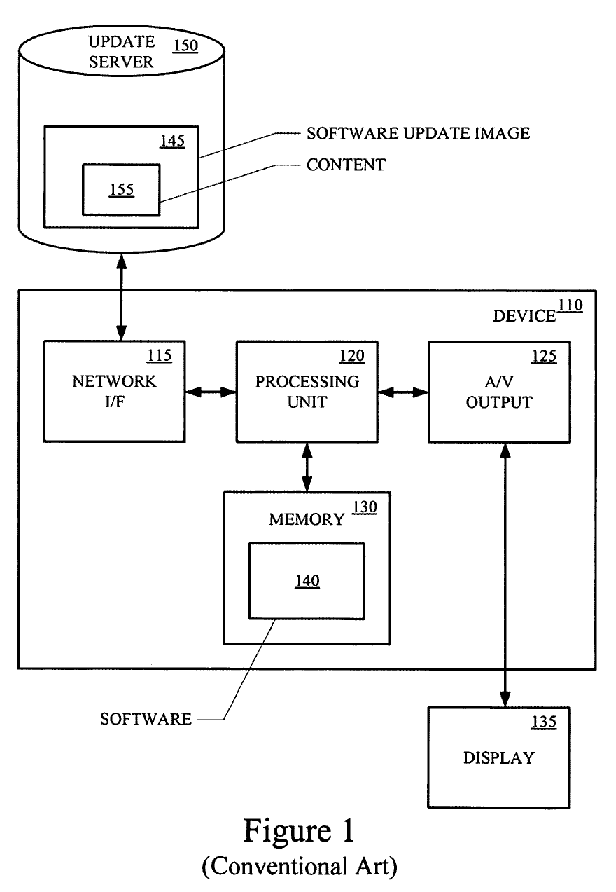

FIG. 2 shows a block diagram of a system for updating software, in accordance with one embodiment of the present technology.

FIG. 3 shows a flow diagram of a method for updating software, in accordance with one embodiment of the present technology.

FIG. 4 shows a flow diagram of a method for displaying content associated with a software update image, in accordance with another embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

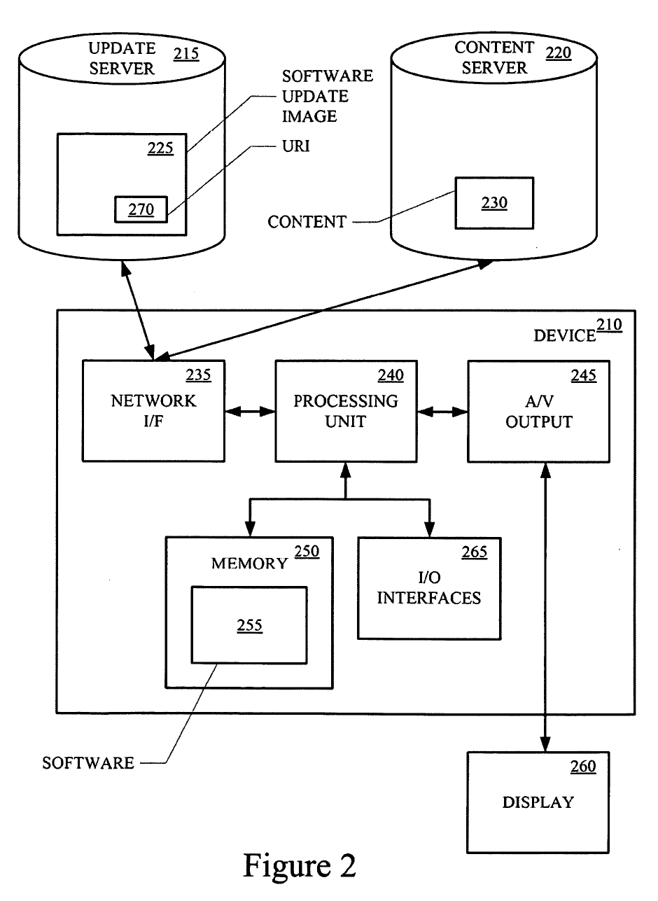

Referring now to FIG. 2 a system for updating software, in accordance with one embodiment of the present technology, is shown. The system includes a device 210 that is communicatively coupled to an update server 215 and a content server 220. The device 210 may be any type of network enabled device, such a computer, game console, set top box (STB), television, smart phone, entertainment system, or the like. The update server 215 includes computing device readable media for storing one or more software update images 225. The content server 220 includes computing device readable media for storing content 230 associated with one or more software update images 225 stored on the update server 215. Although the update server 215 and content server 220 are shown as separate servers, it is appreciated that the update server 215 and content server 220 may be implemented by a single server, where the software update image 225 is stored separately from the content 230. For example, a single server may store the software update images 225 in a first data structure (e.g., file, directory or the like) and the content in a second data structure.

The device 210 includes a network interface 235, a processing unit 240, an audio/video (A/V) output 245 and memory 250. The memory 250 may include one or more computing device readable media, such as non-volatile read-only memory (ROM), flash memory, volatile random access memory (RAM), optical storage (e.g., CD/DVD disk and drive), magnetic storage (e.g., hard disk drive (HDD)), and/or the like. The memory 250 stores computing device executable commands and data (e.g., one or more software applications) 255. The processing unit 240 implements one or more functions of the device 210 by executing one or more of the software application 255 stored in the memory 250. The device 210 may be communicatively coupled to a display 260 through the A/V output 245. Although the display 260 is shown as an external peripheral of the device 210, it is appreciated that the display may be an integral component of the device 210. The device 210 may also include one or more input/output (I/O) interface 265. The additional I/O interfaces 265 may include a control panel, remote control, keyboard, pointing device (e.g., mouse), game controller, speaker, microphone, printer and/or the like. The additional I/O interfaces 265 may be integral to the device 210 and/or external peripherals communicatively coupled to the device 210.

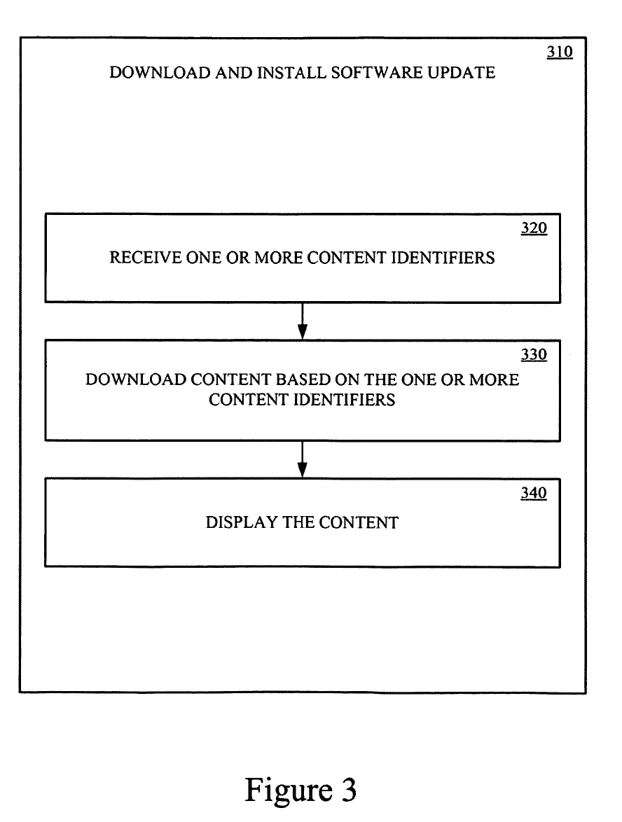

The software 255 may be updated by downloading and installing a given software update image 225. The download process may be initiated by a user through use of one or more I/O device 265 such as the keyboard and/or mouse and a graphical user interface (GUI) on the display 260. Alternatively, the download process may be automatically initiated by an update routine or application. Operation of the system will be further described with reference to FIG. 3, which shows a method for updating software, in accordance with one embodiment of the present technology. To update a given software application 255, a given software update image 225 may be downloaded and installed from the update server 215, at 310. During the download and installation of the software update image 225, one or more content identifiers 270 may be received, at 320. In particular, the software update image 150 may include one or more content identifier 270 of content 230 associated with the software update image 225. The content identifiers 270 may be uniform resource identifiers (URIs), uniform resource locators (URLs), uniform resource names (URNs), hyperlinks or the like. At 330, the content 230 corresponding to the one or more identifiers 270 may be downloaded from the content server 220. The content 230 may be images (e.g., pictures), graphics, audio (e.g., music), video, audio and video and/or the like. For example, the content 230 may be an introduction to new features contained in the software update. In another example, the content 230 may be a product offering. In yet another example, the content 230 may be entertainment information. At 340, some or all of the content 230 downloaded from the content server 220 may be output on one or more input/output interfaces 260, 265 of the device 210. For example, picture, graphic and video content 230 may be output on the display 260, audio content may be output on speakers and/or pictures and graphics may be output on a printer. In addition, only a particular portion of the content may be output based upon an operating parameter. For example, the portion of the content 230 formatted in a given language may be displayed based upon a user setting or preference.

The content 230 may be downloaded from the content server 220 and/or output by the networked device 210 during the download and/or installation of the software update, as illustrated in FIG. 3. In addition, the content 230 may be downloaded from the content server 220 and/or output by the networked device 210 sometime after the software update is downloaded and/or installed. For example, an advertisement may be output on the display 260 and/or speakers the next time a network game is started after the software of the network game has been updated. The advertisement may, for example, be directed toward other network games that a user may purchase. In another example, the image at the location of the one or more URIs may be displayed multiple times over a period of time (e.g., each of a plurality of days). Furthermore, the images at the location of the URIs may be changed each day. Therefore a different advertisement can be delivered to the user of the device 210 each day.

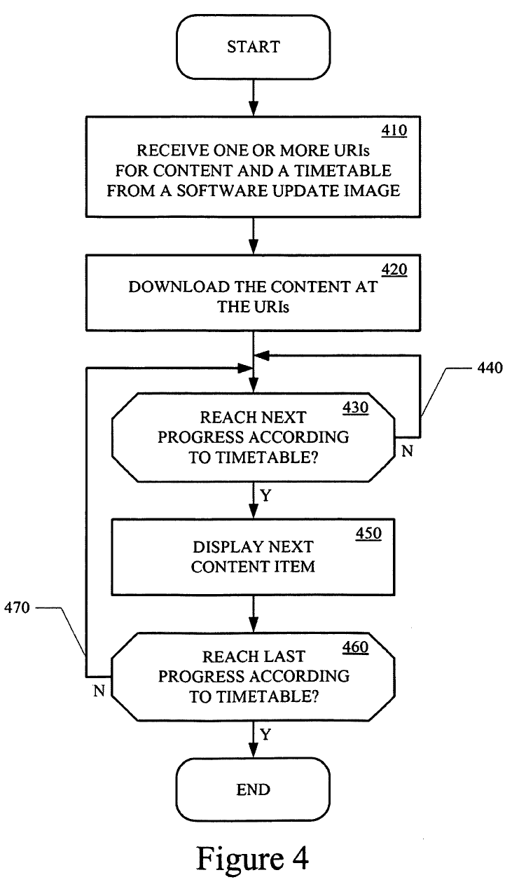

Referring now to FIG. 4, a method for displaying content associated with a software update image, in accordance with another embodiment of the present technology, is shown. During the downloading of a software update image, one or more content identifiers of one or more content items and a timetable for displaying the content may be received in the software update image, at 410. The content identifiers may be uniform resource identifiers (URIs), uniform resource locators (URLs), uniform resource names (URNs), hyperlinks or the like. The timetable may include a plurality of records, wherein each record includes an identification number, a progress point, a uniform resource locator, a condition and/or the like, as follows:

| ID# | Progress | URL | Condition |
|---|---|---|---|
| 1001 | 10 | www.dist_pictures.com/aaa/bbb | |
| 1002 | 20 | www.dist_pictures.com/usa/ccc | country == “USA” |
| 1003 | 20 | www.dist_picutres.com/can/ddd | country == “CAN” |

The progress point may specify a point within the download and/or installation of the software update image, a period of time, or similar event.

At 420, the content at the one or more content identifiers is downloaded. A given content item may be downloaded when a corresponding progress point is reached. Alternatively, the content item may be been downloaded prior to when its corresponding progress point is reached. At 430, it is determined whether a next process point according to the timetable has been reached. If a next progress point has not been reached, the process continues 440 to determine whether a next progress point has been reached. If a next progress point has been reached, a next content item is output, at 450. The next progress point maybe associated with one or more URLs by the timetable. If the next progress point is associated with a plurality of URLs, a condition may be used to determine which content at the given plurality of URLs is displayed. For example, an operating parameter (e.g., user setting or preference) may indicate a given country. The content item to be display is output based upon the URL associated with the condition that matches the operating parameter. The content item may be a picture, a graphic, an audio, a video, and/or the like.

At 460, it is determined if a last progress point according to the timetable has been reached. If a last progress point has not been reached, the process continues 470 to determine whether a next progress point has been reached. If the last progress point has been reached, the process for displaying content ends.

Embodiments advantageously provide improved techniques for delivering and displaying content along with downloading and updating software. By including a small identifier of the content associated with the software update in the software update image, it is easier to show different images depending on user settings or preferences while reducing the software update image size. In addition, the content may be changed without having to change the software update image. Similarly, the software update may be changed without having to change the associated content.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the Claims appended hereto and their equivalents.

What is claimed is:

1. A method comprising:
receiving one or more content identifiers during downloading of a software update image from a first data structure;
downloading content based on the one or more content identifiers from a second data structure; and
outputting the content.

2. The method according to claim 1, wherein each content identifier comprises a uniform resource identifier.

3. The method according to claim 2, wherein the content is downloaded from a location at the uniform resource identifier.

4. The method according to claim 1, wherein the content includes one or more content types selected from the group consisting of an image type, a graphic type, an audio type, a video type and an audio/video type.

5. The method according to claim 1, wherein the content is downloaded during downloading or installation of the software update image.

6. The method according to claim 1, wherein the content is downloaded after downloading and installation of the software update image.

7. The method according to claim 1, wherein the content is output during downloading or installation of the software update image.

8. The method according to claim 1, wherein the content is output after downloading and installation of the software update image.

9. The method according to claim 1, further comprising changing the content without changing the software update image.

10. The method according to claim 1, further comprising changing the software update image without changing the content.

11. A system comprising:
an update server for storing one or more software update images, wherein at least one of the software update images includes one or more content identifiers;
a content server for storing one or more content items associated with one or more of the software update images; and
a network device for downloading a given software update image that includes one or more content identifiers from the update server, and for downloading at least one of the content items from the content server based on the one or more content identifiers included in the given software update image and outputting the at least one content item on one or more input/output interfaces of the device.

12. The system of claim 11, wherein each content identifier is a uniform resource indicator, a uniform resource locator, uniform resource number, or hyperlink.

13. The system of claim 11, wherein the one or more content items include one or more audio content items, image content items, picture content items, graphic content items, audio content items, video content items and audio/video content items.

14. The system of claim 11, wherein the one or more input/output interfaces include one or more of a display, a speaker, and a printer.

15. A method comprising:
downloading a software update image;
receiving from the software update image one or more uniform resource identifiers and a timetable;
downloading content at the one or more uniform resource identifiers;
determining if a next progress point has been reached according to the timetable; and
outputting a next portion of the content according to the timetable if the next progress point has been reached.

16. The method according to claim 15, wherein the content comprises software update information.

17. The method according to claim 15, wherein the content comprises product offering information.

18. The method according to claim 15, wherein outputting a next portion of the content comprises outputting a given version of the next portion of the content according to a condition associated with the next progress point by the timetable.

19. The method according to claim 15, wherein the content is output during installation of the software update image.

20. The method according to claim 15, wherein the content is output after installation of the software update image.
